(19) United States
(12) Patent Application Publication
(10) Pub. No.: US 2012/0233153 A1
(43) Pub. Date: Sep. 13, 2012

(54) HIERARCHICAL BROWSING OPERATIONS ON A DIRECTORY ATTRIBUTE

(75) Inventors: John S. Roman, Lowell, MA (US); William A. Spencer, Westford, MA (US)

(73) Assignee: INTERNATIONAL BUSINESS MACHINES CORPORATION, Armonk, NY (US)

(21) Appl. No.: 13/046,465

(22) Filed: Mar. 11, 2011

(51) Int. Cl. G06F 17/30

(52) U.S. Cl. 707/722; 707/E17.014

(57) ABSTRACT

Techniques are disclosed for generating a hierarchical view from a directory attribute stored in a directory. In one embodiment, a user request is received to query a directory attribute of a directory service. One or more search requests are issued against a directory service according to a protocol, where each search request specifies: (i) the directory attribute, (ii) a search key, and (iii) a maximum count of result entries to be returned by the directory service for the respective search request. The hierarchical view may be generated from result entries retrieved responsive to the one or more search requests.

### BACKGROUND

Information describing various users, applications, files, printers and other resources accessible in a multi-user environment may be stored into a special data structure referred to as a directory. Applications may use one or more protocols and/or application programming interfaces (APIs) to access and/or update the information in the directory. A directory may be configured to efficiently handle a large number of access requests, relative to a number of update requests. In particular, the number of access requests for a directory may often exceed the number of update requests by at least an order of magnitude.

### SUMMARY

Embodiments of the invention provide a computer-implemented method, computer program product and system for performing an operation that includes receiving a user request for a hierarchical view of a directory attribute stored in a directory. The operation also includes issuing one or more search requests against a directory service of the directory, wherein each search request specifies: (i) the directory attribute, (ii) a search key, and (iii) a maximum count of result entries to be returned by the directory service for the respective search request. The operation also includes receiving a plurality of result entries from the directory service, responsive to the one or more search requests, wherein each result entry of the plurality of result entries contains text stored in the directory attribute and matching the search key specified in the respective search request, and wherein the text includes a plurality of sub-attributes separated by a first delimiter. The operation also includes generating the hierarchical view from the result entries and based on the sub-attributes. The operation also includes outputting the hierarchical view for display.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a system for generating a hierarchical view from one or more directory attributes stored in a directory, according to one embodiment of the invention.

FIG. 2 illustrates data stored in a first directory attribute, according to one embodiment of an invention.

FIG. 3 illustrates transformed data stored in a second directory attribute, according to one embodiment of the invention.

FIG. 4 illustrates a hierarchical view showing the topmost non-root level of a data hierarchy, according to one embodiment of the invention.

FIGS. 5A-5C illustrate expanded hierarchical views, according to one embodiment of the invention.

FIG. 6 is a flowchart depicting a method for generating a hierarchical view, according to one embodiment of the invention.

FIG. 7 is a flowchart depicting a method for servicing browsing operations on a hierarchical view, according to one embodiment of the invention.

### DETAILED DESCRIPTION

Embodiments of the invention provide techniques for hierarchical browsing of one or more text attributes stored in a directory. One embodiment provides an application configured to access the directory via a directory service that supports one or more predefined protocols and/or application programming interfaces (APIs). The application may access the directory to retrieve the one or more text attributes, responsive to a user request. Depending on the embodiment, the user request may include a search key. In some embodiments, the application may also specify a maximum count of result entries to be retrieved. The result entries may contain text matching the search key included in the user request. The text may include sub-attributes separated by a delimiter character. The application may generate a hierarchical view based on the result entries and output the hierarchical view for display. The hierarchical view may support various hierarchical browsing operations, such as expanding and/or collapsing a specified sub-attribute, outputting a next set or previous set of sub-attributes at a specified level of the hierarchical view, and displaying one or more sub-attributes at a topmost level of the hierarchical view. Advantageously, the application is configured to allow users to browse the one or more text attributes more conveniently and/or efficiently at least in some cases.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java™, Smalltalk™, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g., an amount of storage space consumed by a user or a number of virtualized systems instantiated by the user). A user can access any of the resources that reside in the cloud at any time, and from anywhere across the Internet. In context of the present invention, a directory service may execute in the cloud, where the network directory service is configured to provide one or more applications with access to a directory stored in the cloud. Having the directory service execute in the cloud allows the user to access the directory service from any computing system attached to a network connected to the cloud (e.g., the Internet).

The flowchart and block diagrams in the Figures illustrate the architecture, functionality and operation of possible implementations of systems, methods and computer program products according to various embodiments of the present invention. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

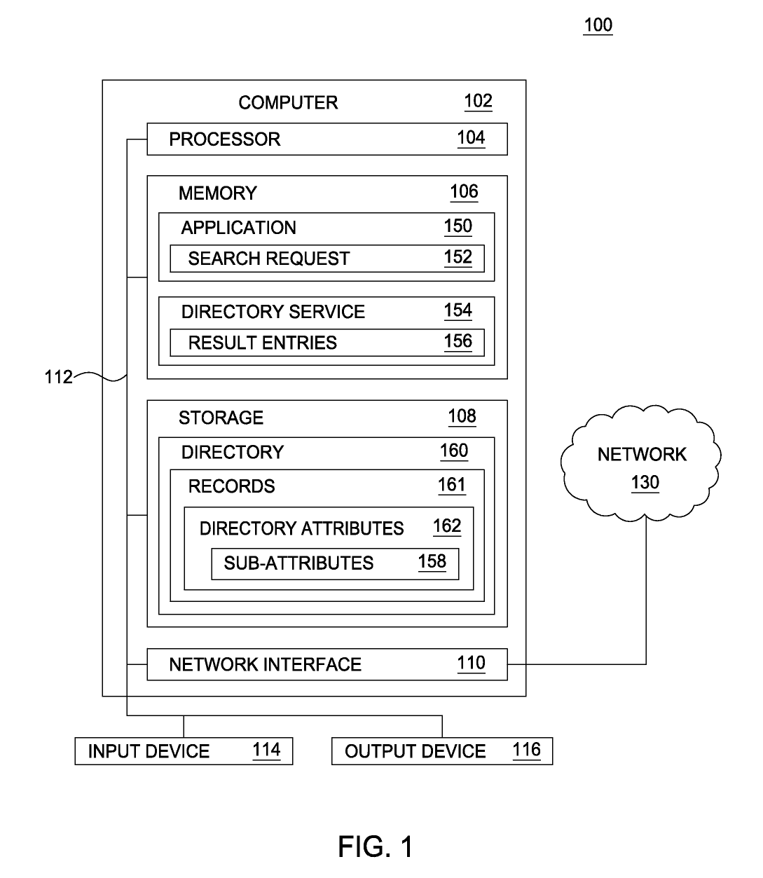

FIG. 1 is a block diagram illustrating a system 100 for generating a hierarchical view from one or more directory attributes stored in a directory, according to one embodiment of the invention. The networked system 100 includes a computer 102 that is connected to a data source 170 via a network 130. The computer 102 may also be connected to other computers via the network 130. In general, the network 130 may be a telecommunications network and/or a wide area network (WAN). In a particular embodiment, the network 130 is the Internet.

The computer 102 generally includes a processor 104 connected via a bus 112 to a memory 106, a network interface device 110, a storage 108, an input device 114, and an output device 116. The computer 102 is generally under the control of an operating system. Examples of operating systems include UNIX, versions of the Microsoft Windows® operating system, and distributions of the Linux® operating system. More generally, any operating system supporting the functions disclosed herein may be used. The processor 104 is included to be representative of a single CPU, multiple CPUs, a single CPU having multiple processing cores, and the like. Similarly, the memory 106 may be a random access memory. While the memory 106 is shown as a single identity, it should be understood that the memory 106 may comprise a plurality of modules, and that the memory 106 may exist at multiple levels, from high speed registers and caches to lower speed but larger DRAM chips. The network interface device 110 may be any type of network communications device allowing the computer 102 to communicate with other computers via the network 130.

The storage 108 may be a persistent storage device. Although the storage 108 is shown as a single unit, the storage 108 may be a combination of fixed and/or removable storage devices, such as fixed disc drives, solid state drives, floppy disc drives, tape drives, removable memory cards or optical storage. The memory 106 and the storage 108 may be part of one virtual address space spanning multiple primary and secondary storage devices. Further, as described above, the application 150 receives identity records and/or entity accounts from the data source 170. Additionally or alternatively, the application 150 may also receive identity records and/or entity accounts via the storage 108.

The input device 114 may be any device for providing input to the computer 102. For example, a keyboard, keypad, light pen, touch-screen, track-ball, or speech recognition unit, audio/video player, and the like may be used. The output device 116 may be any device for providing output to a user of the computer 102. For example, the output device 116 may be any conventional display screen or set of speakers, along with their respective interface cards, i.e., video cards and sound cards (not shown). Although shown separately from the input device 114, the output device 116 and input device 114 may be combined. For example, a display screen with an integrated touch-screen, a display with an integrated keyboard, or a speech recognition unit combined with a text speech converter may be used.

As shown, the memory 106 of the computer 102 includes an application 150 and a directory service 154. The storage 108 of the computer 102 includes a directory 160 that stores records 161, each record containing one or more directory attributes 162. Each directory attribute 162 contains multiple sub-attributes 158. As described above, in one embodiment, the application 150 is configured to access the directory 160 via the directory service 154, where the directory service 154 supports one or more predefined protocols and/or APIs. The application 150 may submit a search request 152 to the directory service 154, to retrieve one or more of the directory attributes 162 stored in the directory 160. Depending on the embodiment, the search request 152 may specify a target directory attribute, a search key, and/or a maximum count of entries to retrieve. In response, the directory service 154 returns result entries 156 to the application 150. Depending on the embodiment, each result entry 156 corresponds to a record or one or more directory attributes thereof. Each result entry 156 contains text stored in the target directory attribute and matching the search key. Further, the text includes sub-attributes separated by a delimiter. The application 150 reorganizes the result entries into a hierarchical view, based on the sub-attributes. The application 150 then outputs the hierarchical view for display. Using the techniques disclosed herein, a user of the application may browse the one or more attributes more conveniently and/or efficiently at least in some cases.

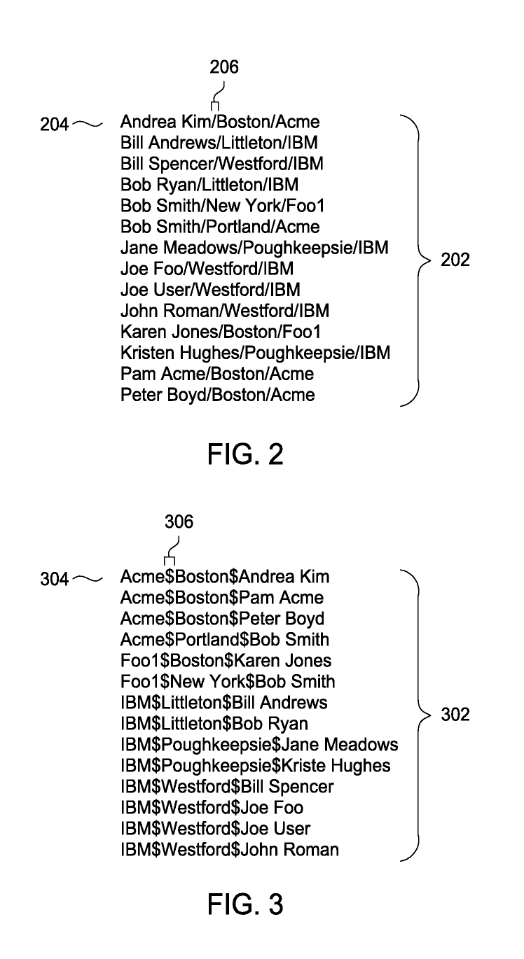

FIG. 2 illustrates data 202 stored in a first directory attribute, according to one embodiment of an invention. Assume that the directory attribute stores data about users in a multi-user environment and is named “NameAlias”. The directory attribute may store data in the form of text. In at least some cases, however, the text may contain sufficient information from which to generate a data hierarchy. Specifically, the text may contain several sub-attributes separated by a delimiter. Further, the sub-attributes may be sorted in ascending or descending order based on depth in a data hierarchy for the directory attribute. In an alternative embodiment, the sub-attributes may be sorted in any predefined order. As described above, in response to a search request, the directory service 154 returns one or more records and/or attributes matching the search request. The records and/or attributes may be sorted in any predefined order, such as in an alphabetical order (e.g., as shown for the data 202). Further, where the search request specifies to retrieve all records and/or attributes, the directory service 154 returns all records and/or attributes stored in the directory 160.

As shown, a first record in the directory stores the text “Andrea Kim/Boston/Acme” 204 for the NameAlias directory attribute. The text contains three sub-attributes separated by a backslash delimiter 206. Of course, those skilled in the art will recognize that any predefined delimiters may be used, including predefined delimiters of any length. Further, the sub-attributes are ordered based on decreasing depth in a data hierarchy for the NameAlias directory attribute. The data hierarchy includes a root level, a company name at the topmost non-root level (e.g., “Acme”), an office location at the second non-root level (e.g., “Boston”), and an employee name at the third non-root level (e.g., “Andrea Kim”). Of course, those skilled in the art will recognize that the data hierarchy may also support any count of levels, including counts greater than three.

As another example, suppose the first record in the directory stores the text “Fresh Seafood Restaurant, Main St., Littleton, Mass., US” for a “FavoritePlace” directory attribute storing data about favorite places of users. The text contains five sub-attributes separated by a comma delimiter (“,”). Further, the sub-attributes are ordered based on decreasing depth in a data hierarchy for the FavoritePlace directory attribute. The data hierarchy includes a country at the topmost or root level (e.g., “US”), a state at the second level (e.g., “MA”), a city at the third level (e.g., “Littleton”), a street name at the fourth level (e.g., “Main St.”), and a location name at the fifth level (e.g., “Fresh Seafood Restaurant”).

As described above, in one embodiment, the application 150 may generate a hierarchical view based on data stored in a directory attribute, where the data contains sub-attributes. Although embodiments are described herein with reference to the application 150 generating the hierarchical view, depending on the embodiment, some or all of the functionality of the application 150 may be performed by the directory service 154. To generate the hierarchical view, the application 150 may first transform the data into a format suitable for generating the hierarchical view, which may include reordering and/or replacing the delimiter in the data. The transformed data may then be stored in a second directory attribute in the directory. For example, the second directory attribute storing transformed data from the NameAlias directory attribute may be named “NameAliasHierarchy”.

FIG. 3 illustrates transformed data 302 stored in the second directory attribute, according to one embodiment of the invention. In one embodiment, to transform the data into the format suitable for generating the hierarchical view, the application 150 may first determine whether the sub-attributes are ordered based on increasing depth in a data hierarchy. If not, the application 150 reorders the sub-attributes based on increasing depth in the data hierarchy and stores the reordered attributes as a second directory attribute in the directory 160.

As described above, in one embodiment, to transform the data into the format suitable for generating the hierarchical view, the application 150 may select a delimiter to be used for separating sub-attributes of the directory attribute. The delimiter may be selected such that the delimiter does not appear in any sub-attribute of the directory attribute. Further, to facilitate hierarchical browsing operations further described below, the delimiter may also be selected such that the preceding and/or succeeding characters also do not appear in any sub-attribute of the directory attribute. The preceding and succeeding characters may be determined according to any predefined character-encoding scheme. Examples of character-encoding schemes include American Standard Code for Information Interchange (ASCII) and Unicode. Depending on the embodiment, the preceding and/or succeeding characters may precede or succeed the delimiter by more than one position in the character-encoding scheme. In general, any predefined count of positions may be used, and the count of positions may differ between the preceding character and the succeeding character. Further, depending on the embodiment, a global delimiter may be selected that does not appear in any sub-attribute of any directory attribute stored in the directory.

As an example, the application 150 may replace the backslash delimiter 206 with a dollar-symbol delimiter 306. After reordering and replacing the delimiter in the data, the text “Andrea Kim/Boston/Acme” 204 is transformed into “Acme$Boston$Andrea Kim” 304. Further, ordering the NameAliasHierarchy directory attribute alphabetically results in ordering each level of the data hierarchy, from the topmost level of the hierarchy downward. For example, the company name “Acme” appears in the transformed data 302 prior to the company name “Fool”. Further, within the company name “Acme”, the office location “Boston” appears in the transformed data 302 prior to the office location “Portland”.

In one embodiment, the application 150 may also request to index the second directory attribute in the directory 160. The second directory attribute may be indexed alphabetically as a text attribute. At least in some cases, indexing the second directory attribute allows one or more controls to be used in conjunction with the second directory attribute. An example of a control is a Virtual List View (VLV) control of the Lightweight Directory Access Protocol (LDAP). LDAP refers to an application protocol for accessing and updating information in a directory. The VLV control allows the application 150 to specify that the directory service 154 return, for a given search request, a contiguous subset of a larger search result set. For example, the directory service 154 may return ten search results at a time from an overall set of a million search results. By allowing a user to scroll through subsets of the larger search result set, the application 150 and/or the directory service 154 may create an illusion that the larger search result set has been retrieved, without incurring the costs of retrieving the larger search result set, such as in terms of memory, processing, and/or network costs. Of course, the VLV control is exemplary and not intended to be limiting of the disclosure. In alternative embodiments, other controls and/or other directory protocols may be used.

In one embodiment, once the second directory attribute is stored and indexed in the directory 160, the application 150 may send a search request to the directory service 154. Depending on the embodiment, the search request may specify a VLV control. The search request specifying a VLV control may be referred to herein as a VLV request. The VLV request specifies to find a record position by using a search key or a position number and retrieve a specified count of contiguous entries preceding or succeeding the record position. Depending on the embodiment, the specified count of entries may include or exclude the entry at the record position. If there is no match, then the entries returned may include entries preceding or succeeding a position that a hypothetical, matching entry would have occupied. As an example, the VLV request may specify “Foo1$B” as the search key. Further, the VLV request may specify to retrieve three contiguous entries, starting from a first entry matching the search key. Table I shows the entries returned by the directory service 154 to the application 150, responsive to the VLV request.

TABLE I
Entries returned responsive to the VLV request

Foo1$Boston$Karen Jones
Foo1$New York$Bob Smith
IBM$Littleton$Bill Andrews

As shown above, in response to the VLV request, the directory service 154 returns three contiguous entries, starting from the entry “Foo1$Boston$Karen Jones”, which is the first entry matching the search key. The three contiguous entries would also be returned responsive to a VLV request specifying “Foo0$” as the search key, even though “Foo0$” does not match any entries in the directory.

In one embodiment, the application 150 generates the hierarchical view using one or more VLV requests. The application 150 may also support hierarchical browsing operations on the hierarchical view, by issuing VLV requests to the directory service 156. The result of a hierarchical browsing operation on a hierarchical view is another hierarchical view. Hierarchical browsing operations include outputting a topmost level of a data hierarchy, expanding or collapsing a specified level of the data hierarchy, outputting a next set of sub-attributes at a specified level of the data hierarchy, and outputting matches in the directory attribute based on a search key specified in a user request. In one embodiment, a first hierarchical view generated by the application 150 includes a root level or a topmost non-root level of a data hierarchy.

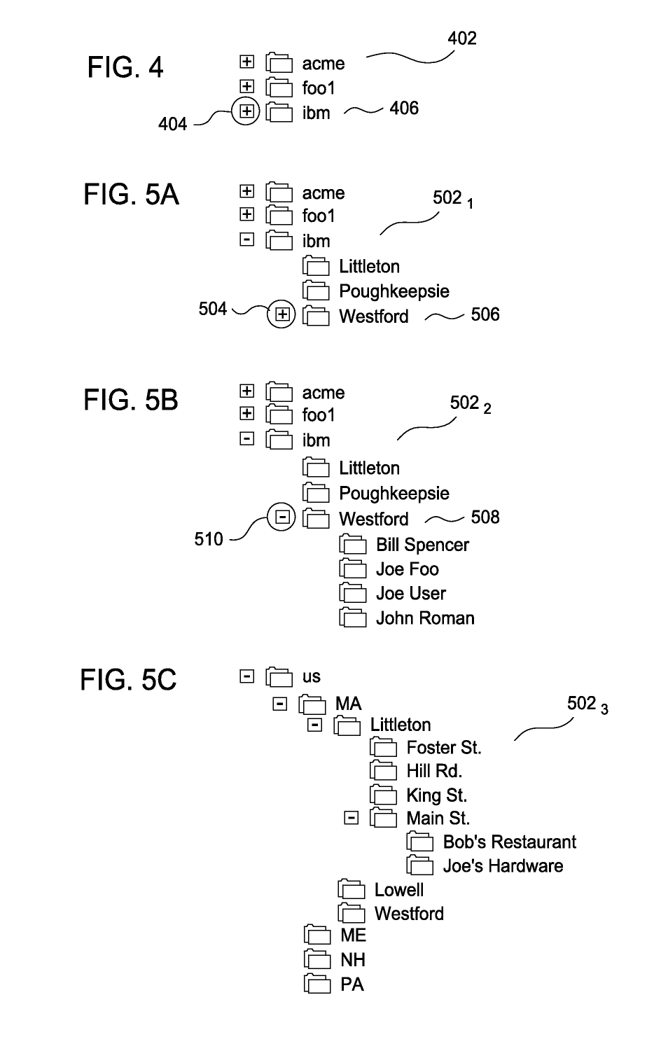

FIG. 4 illustrates a hierarchical view 402 showing the topmost non-root level of a data hierarchy, according to one embodiment of the invention. As shown, the hierarchical view 402 includes three entries that represent Acme, Fool, and IBM, respectively. The hierarchical view 402 may include up to a predefined count of entries to output. The application 150 may determine the predefined count of entries based on how many entries would fit on a GUI screen of the application 150. In this specific example, the predefined count of entries to output is three. Accordingly, the application 150 may issue a first VLV request to the directory service 154 to retrieve the first three entries stored in the directory 160. Table II shows the first three entries returned in response to the first VLV request.

TABLE II
Entries returned responsive to the first VLV request

Acme$Boston$Andrew Kim
Acme$Boston$Pam Acme
Acme$Boston$Peter Boyd

The application 150 may then parse the first sub-attribute (“Acme”) and designate the parsed sub-attribute for inclusion in the hierarchical view.

Next, the application 150 determines if the first three entries include any other first sub-attribute (e.g., “Foo1” or “IBM”). If so, the application 150 also designates the other first sub-attribute for inclusion in the hierarchical view. On the other hand, if the first three entries do not include any other first sub-attribute, then the application 150 issues a second VLV request to retrieve three entries after the first sub-attribute, “Acme”. For example, the VLV request may specify the search key “Acme %”, where the search key is obtained by concatenating the first sub-attribute “Acme” with a character immediately succeeding the dollar-sign delimiter, according to the ASCII character-encoding scheme. In this specific example, the immediately-succeeding character is the percent character (“%”). Table III shows the first three entries returned in response to the second VLV request.

TABLE III
Entries returned responsive to the second VLV request

Foo1$Boston$Karen Jones
Foo1$New York$Bob Smith
IBM$Littleton$Bill Andrews

The application 150 may then parse any distinct sub-attributes (“Foo1” and “IBM”) and designate the parsed sub-attributes for inclusion in the hierarchical view. The first distinct sub-attribute refers to any first sub-attribute that is distinct relative to first sub-attributes that were previously encountered.

Next, the application 150 determines if any other distinct first sub-attributes remain. This determination may be made by issuing a third VLV request using the search key “IBM %”, where the search key is obtained by concatenating the latest first attribute “IBM” with the percent character. If the directory service 154 returns one or more entries, then other distinct first sub-attributes remain, and the application 150 parses and designates the other distinct first sub-attributes for inclusion in the hierarchical view. On the other hand, if the directory service 154 does not return any entry, then no distinct first sub-attributes remain, and the hierarchical view may be output to the user. Further, in one embodiment, if the predefined count of entries to output is exceeded at any time in generating the hierarchical view, the application 150 may refrain from issuing additional VLV requests until the user requests to scroll to a next set of sub-attributes.

In one embodiment, the application 150 may also support expanding or collapsing a specified level of the data hierarchy. Suppose that the user requests to expand the “IBM” entry 406, such as by clicking on an expand icon 404 proximate to the “IBM” entry 406. In response, the application 150 may issue a fourth VLV request using the search key “IBM $”, where the search key is obtained by concatenating the entry desired to be expanded, with the predefined delimiter. Table IV shows the first three entries returned in response to the fourth VLV request.

TABLE IV
Entries returned responsive to the fourth VLV request

IBM$Littleton$Bill Andrews
IBM$Littleton$Bob Ryan
IBM$Poughkeepsie$Jane Meadows

The application 150 may then identify the distinct second sub-attributes (“Littleton” and “Poughkeepsie”) and designate the identified sub-attributes for inclusion in the second non-root level of the hierarchical view.

Next, the application 150 determines if any other distinct second sub-attributes remain. This determination may be made by issuing a fifth VLV request using the search key “IBM$Poughkeepsie %”, where the search key is obtained by concatenating the latest, fully-qualified second attribute “IBM$Poughkeepsie” with the percent character. Table V shows the first three entries returned in response to the fifth VLV request.

TABLE V
Entries returned responsive to the fifth VLV request

IBM$Westford$Bill Spencer
IBM$Westford$Joe Foo
IBM$Westford$Joe User

The application 150 may then identify the distinct second sub-attribute (“Westford”) and designate the identified sub-attribute for inclusion in the second non-root level of the hierarchical view.

Next, the application 150 issues additional VLV requests until no further entries are returned, at which point the (expanded) hierarchical view may be output to the user. For example, the application 150 may issue a sixth VLV request using the search key “IBM$Westford %”, where the search key is obtained by concatenating the latest, fully-qualified second attribute “IBM$Westford” with the percent character. In response, the directory service 154 returns zero entries to the application 150. Further, in one embodiment, if the predefined count of entries to output is exceeded at any time in generating the expanded hierarchical view, the application 150 may refrain from issuing additional VLV requests until the user requests to scroll to a next set of sub-attributes.

FIGS. 5A-5C illustrate expanded hierarchical views 502 generated by the application 150, according to one embodiment of the invention. As shown in FIG. 5A, the expanded hierarchical view 502₁ includes the office locations Littleton, Poughkeepsie, and Westford at a second non-root level of the data hierarchy—as well as the company names at the topmost non-root level of the data hierarchy. Suppose a user requests to expand the Westford entry 506, e.g., by clicking on an expand icon 504 proximate to the Westford entry 506. The application 150 may use the techniques disclosed above to expand the Westford entry and to generate the hierarchical view 502₂ of FIG. 5B. As shown, the hierarchical view 502₂ includes the employee names Bill Spencer, Joe Foo, Joe User, and John Roman at a second non-root level of the data hierarchy—in addition to the office locations and company names from higher levels of the data hierarchy. Further, those skilled in the art will recognize that the techniques disclosed herein may be adapted to generate collapsed views. For example, suppose a user requests to collapse the Westford entry 508, by clicking on a collapse icon 510 proximate to the Westford entry 508. In response, the application 150 may generate a collapsed view that corresponds to the hierarchical view 502₁ of FIG. 5A. In other words, the hierarchical view generated from collapsing the Westford entry 508 may be identical or similar to the hierarchical view generated from expanding the IBM entry 406. Further, the hierarchical view 502₃ of FIG. 5C illustrates an expanded hierarchical view of the FavoritePlace directory attribute described above. As shown, the hierarchical view 502₃ includes expansions of the US, MA, Littleton, and Main St. sub-attributes.

In one embodiment, using the techniques disclosed above, the application 150 may also support outputting a next set or previous set of sub-attributes at a specified level of the data hierarchy. To output a next set of sub-attributes at a specified level of the data hierarchy, the application 150 may issue a VLV request using a search key obtained from concatenating the fully-qualified, last visible sub-attribute at the specified level, with the percent character. To output a previous set of sub-attributes at a specified level of the data hierarchy, the application 150 may issue a VLV request using a search key obtained from concatenating the fully-qualified, first visible sub-attribute at the specified level, with the pound character (“#”). The pound character is selected because the pound character immediately precedes the dollar-sign delimiter, according to the ASCII character-encoding scheme. Similarly, the application 150 may issue additional VLV requests until the predefined count of entries to output is met.

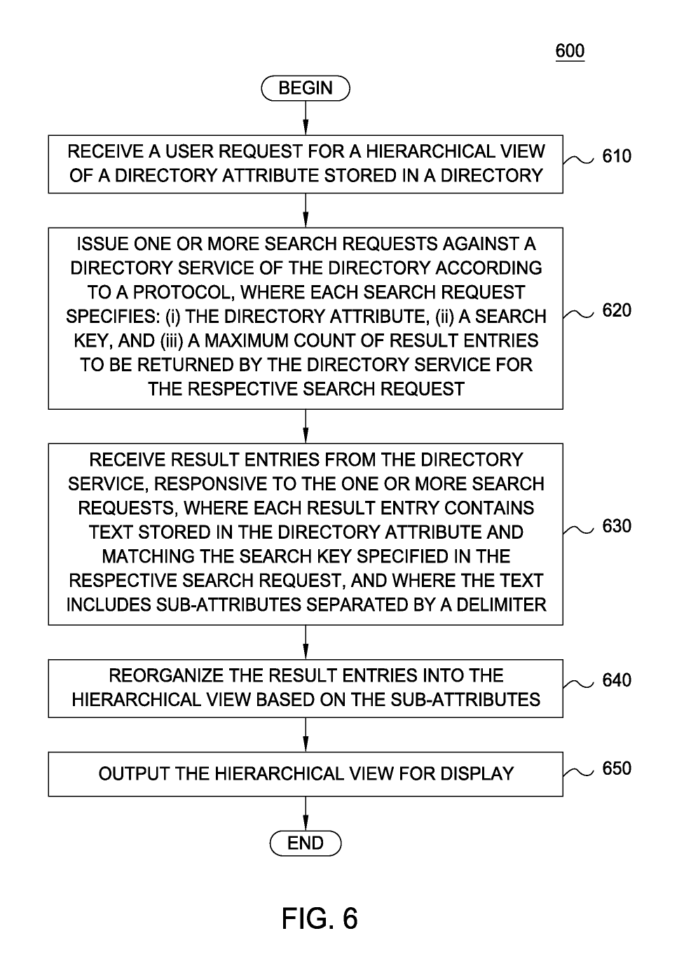

FIG. 6 is a flowchart depicting a method 600 for generating a hierarchical view, according to one embodiment of the invention. As shown, the method 600 begins at step 610, where the application 150 receives a user request for a hierarchical view of a directory attribute stored in the directory 160. At step 620, the application 150 issues one or more search requests against a directory service 154 of the directory 160 according to a protocol, where each search request specifies: (i) the directory attribute, (ii) a search key, and (iii) a maximum count of result entries to be returned by the directory service for the respective search request. At step 630, the application 150 receives result entries from the directory service 154, responsive to the one or more search requests, where each result entry contains text matching the search key specified in the respective search request, and where the text includes sub-attributes separated by a delimiter. At step 640, the application 150 reorganizes the result entries into a hierarchical view based on the sub-attributes. At step 650, the application 150 outputs the hierarchical view for display. After the step 650, the method 600 terminates.

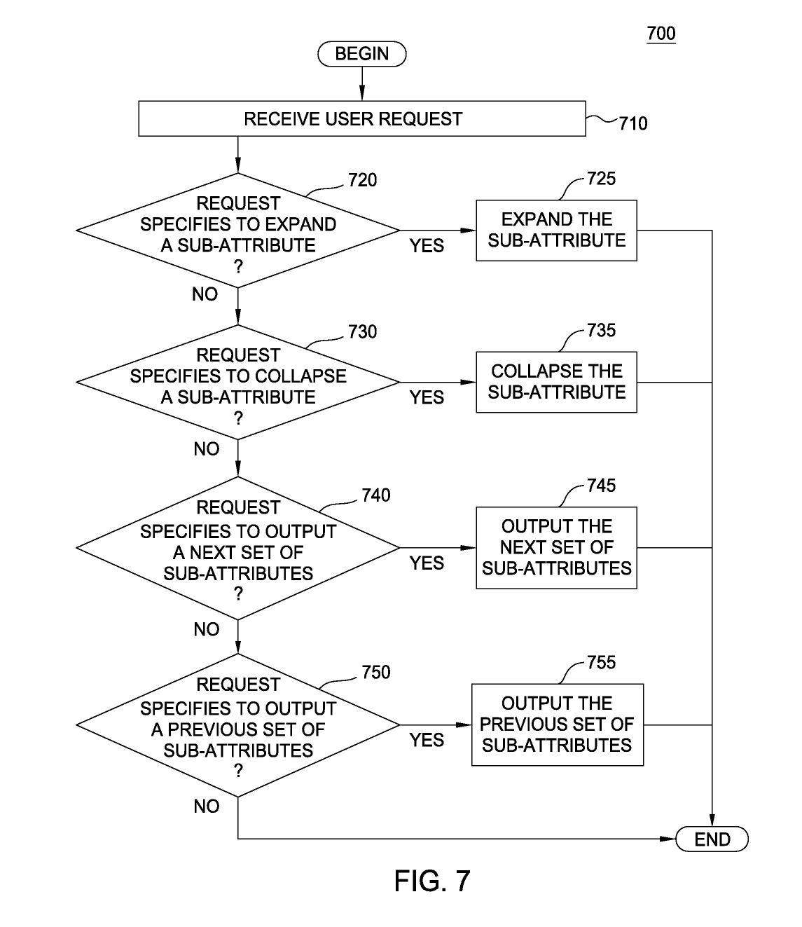

FIG. 7 is a flowchart depicting a method 700 for servicing browsing operations on a hierarchical view, according to one embodiment of the invention. As shown, the method 700 begins at step 710, where the application 150 receives a user request to perform a browsing operation on the hierarchical view. If the user request specifies to expand a sub-attribute (step 720), the application 150 expands the sub-attribute and generates a new hierarchical view reflecting the expanded sub-attribute (step 725). If the user request specifies to collapse a sub-attribute (step 730), the application 150 collapses the sub-attribute and generates a new hierarchical view reflecting the collapsed sub-attribute (step 735). If the user request specifies to output a next set of sub-attributes (step 740), the application 150 retrieves the next set of sub-attributes and generates a new hierarchical view reflecting the next set of sub-attributes (step 745). If the user request specifies to output a previous set of sub-attributes (step 750), the application 150 retrieves the previous set of sub-attributes and generates a new hierarchical view reflecting the previous set of sub-attributes (step 755). As described above, the application 150 may also support other browsing operations, such as searching for matches in a directory attribute based on a search key specified in the user request. After the steps 725, 735, 745, or 755, the method 700 terminates.

Advantageously, embodiments of the invention provide techniques for generating a hierarchical view from a directory attribute stored in a directory. One embodiment provides an application that issues one or more search requests against a directory service according to a protocol, where each search request specifies: (i) the directory attribute, (ii) a search key, and (iii) a maximum count of result entries to be returned by the directory service for the respective search request. The application receives result entries from the directory service, responsive to the one or more search requests, each result entry containing text stored in the directory attribute and matching the search key specified in the respective search request. The text includes sub-attributes separated by a delimiter. The application reorganizes the result entries into a hierarchical view, based on the sub-attributes. The application may also support multiple browsing operations on the hierarchical view. Advantageously, the application is configured to allow users to browse the one or more text attributes more conveniently and/or efficiently at least in some cases, without having to retrieve all entries of the directory attribute stored in the directory, and without reconfiguring the directory server to store a hierarchy of data rather than a flat text attribute. Further, even where the directory may be organized hierarchically by a single directory attribute only, such as by a distinguished name in LDAP, the application is configured to allow users to browse multiple text attributes hierarchically on-the-fly—including text attributes that are not organized hierarchically in the directory.

While the foregoing is directed to embodiments of the present invention, other and further embodiments of the invention may be devised without departing from the basic scope thereof, and the scope thereof is determined by the claims that follow.

What is claimed is:

1. A computer-implemented method, comprising:
receiving a user request for a hierarchical view of a directory attribute stored in a directory;
issuing one or more search requests against a directory service of the directory, wherein each search request specifies: (i) the directory attribute, (ii) a search key, and (iii) a maximum count of result entries to be returned by the directory service for the respective search request;
receiving a plurality of result entries from the directory service, responsive to the one or more search requests, wherein each result entry of the plurality of result entries contains text stored in the directory attribute and matching the search key specified in the respective search request, and wherein the text includes a plurality of sub-attributes separated by a first delimiter;
by operation of one or more computer processors, generating the hierarchical view from the result entries and based on the sub-attributes; and
outputting the hierarchical view for display.

2. The computer-implemented method of claim 1, wherein the hierarchical view includes sub-attributes for a subset of the plurality of result entries.

3. The computer-implemented method of claim 1, wherein a maximum count of sub-attributes in the hierarchical view to be output for simultaneous display is determined based on dimensions of an output window.

4. The computer-implemented method of claim 1, further comprising:
receiving a user request to perform a predefined action on a sub-attribute in the hierarchical view; and
performing the predefined action responsive to the request.

5. The computer-implemented method of claim 4, wherein the predefined action is selected from at least one of:
expanding the sub-attribute in the hierarchical view;
collapsing the sub-attribute in the hierarchical view;
outputting for display a next set of sub-attributes in the hierarchical view; and
outputting for display a previous set of sub-attributes in the hierarchical view.

6. The computer-implemented method of claim 4, wherein performing the predefined action comprises:
issuing one or more additional search requests against the directory service of the directory, wherein each additional search request specifies: (i) the directory attribute, (ii) a search key, and (iii) a maximum count of result entries to be returned by the directory service for the respective additional search request, and wherein the search key specified in at least one additional search request includes a second delimiter different from the first delimiter; and
modifying the hierarchical view based on results returned from the one or more additional search requests.

7. The computer-implemented method of claim 1, wherein the protocol comprises Lightweight Directory Access Protocol (LDAP), and wherein at least one of the one or more search requests comprises a Virtual List View (VLV) request.

8. A computer program product, comprising:
a computer-readable storage medium having computer-readable program code embodied therewith, the computer-readable program code comprising:
computer-readable program code configured to receive a user request for a hierarchical view of a directory attribute stored in a directory;
computer-readable program code configured to issue one or more search requests against a directory service of the directory, wherein each search request specifies: (i) the directory attribute, (ii) a search key, and (iii) a maximum count of result entries to be returned by the directory service for the respective search request;
computer-readable program code configured to receive a plurality of result entries from the directory service, responsive to the one or more search requests, wherein each result entry of the plurality of result entries contains text stored in the directory attribute and matching the search key specified in the respective search request, and wherein the text includes a plurality of sub-attributes separated by a first delimiter;
computer-readable program code configured to generate the hierarchical view from the result entries and based on the sub-attributes; and
computer-readable program code configured to output the hierarchical view for display.

9. The computer program product of claim 8, wherein the hierarchical view includes sub-attributes for a subset of the plurality of result entries.

10. The computer program product of claim 8, wherein a maximum count of sub-attributes in the hierarchical view to be output for simultaneous display is determined based on dimensions of an output window.

11. The computer program product of claim 8, wherein the computer-readable program code further comprises:
computer-readable program code configured to receive a user request to perform a predefined action on a sub-attribute in the hierarchical view; and
computer-readable program code configured to perform the predefined action responsive to the request.

12. The computer program product of claim 11, wherein the predefined action is selected from at least one of:
expanding the sub-attribute in the hierarchical view;
collapsing the sub-attribute in the hierarchical view;
outputting for display a next set of sub-attributes in the hierarchical view; and
outputting for display a previous set of sub-attributes in the hierarchical view.

13. The computer program product of claim 11, wherein the computer-readable program code configured to perform the predefined action comprises:
computer-readable program code configured to issue one or more additional search requests against the directory service of the directory, wherein each additional search request specifies: (i) the directory attribute, (ii) a search key, and (iii) a maximum count of result entries to be returned by the directory service for the respective additional search request, and wherein the search key specified in at least one additional search request includes a second delimiter different from the first delimiter; and
computer-readable program code configured to modify the hierarchical view based on results returned from the one or more additional search requests.

14. The computer program product of claim 8, wherein the protocol comprises Lightweight Directory Access Protocol (LDAP), and wherein at least one of the one or more search requests comprises a Virtual List View (VLV) request.

15. A system, comprising:
one or more computer processors;
a memory containing a program, which when executed by the one or more computer processors is configured to perform an operation comprising:
receiving a user request for a hierarchical view of a directory attribute stored in a directory;
issuing one or more search requests against a directory service of the directory, wherein each search request specifies: (i) the directory attribute, (ii) a search key, and (iii) a maximum count of result entries to be returned by the directory service for the respective search request;
receiving a plurality of result entries from the directory service, responsive to the one or more search requests, wherein each result entry of the plurality of result entries contains text stored in the directory attribute and matching the search key specified in the respective search request, and wherein the text includes a plurality of sub-attributes separated by a first delimiter;
generating the hierarchical view from the result entries and based on the sub-attributes; and
outputting the hierarchical view for display.

16. The system of claim 15, wherein the hierarchical view includes sub-attributes for a subset of the plurality of result entries.

17. The system of claim 15, wherein a maximum count of sub-attributes in the hierarchical view to be output for simultaneous display is determined based on dimensions of an output window.

18. The system of claim 15, wherein the operation further comprises:
receiving a user request to perform a predefined action on a sub-attribute in the hierarchical view; and
performing the predefined action responsive to the request.

19. The system of claim 18, wherein the predefined action is selected from at least one of:
expanding the sub-attribute in the hierarchical view;
collapsing the sub-attribute in the hierarchical view;
outputting for display a next set of sub-attributes in the hierarchical view; and
outputting for display a previous set of sub-attributes in the hierarchical view.

20. The system of claim 18, wherein performing the predefined action comprises:
issuing one or more additional search requests against the directory service of the directory, wherein each additional search request specifies: (i) the directory attribute, (ii) a search key, and (iii) a maximum count of result entries to be returned by the directory service for the respective additional search request, and wherein the search key specified in at least one additional search request includes a second delimiter different from the first delimiter; and
modifying the hierarchical view based on results returned from the one or more additional search requests.
